(19) United States
(12) Patent Application Publication
(10) Pub. No.: US 2004/0057443 A1
(43) Pub. Date: Mar. 25, 2004

(54) Method for assigning IP address to mobile node in code division multiple access system

(76) Inventors: Sung-Hoon Kim, Suwon-shi (KR); Tai-Yoon Lee, Suwon-shi (KR); Doo-Yong Yang, Seoul (KR)

Correspondence Address: Robert E. Bushnell, Suite 300, 1522 K Street, N.W., Washington, DC, 20005, US

(21) Appl. No.: 10/650,924

(22) Filed: Aug. 29, 2003

(30) Foreign Application Priority Data
Sep. 11, 2002 (KR) 2002-55152

(51) Int. Cl. H04Q 7/00

(52) U.S. Cl. 370/401; 370/329

(57) ABSTRACT

A method for assigning an IP (Internet Protocol) address to an MN (Mobile Node) in a CDMA (Code Division Multiple Access) system, and more particularly to a method for assigning an IP address on the basis of a grade of an MN. In a method for assigning an IP address on the basis of a grade of an MN in a CDMA data communication system, the system including a database storing information of grades of MNs, a grade of the MN is identified from the database when an IP address assignment request associated with an arbitrary MN is received. Then, an IP address pool is selected from IP address pools of various grades on the basis of the grade of the MN, the IP address pools containing assignable IP addresses. Then, an IP address is selected from the IP address pool and the selected IP address is assigned to the MN.

### CLAIM OF PRIORITY

This application makes reference to, incorporates the same herein, and claims all benefits accruing under 35 U.S.C. §119 from an application for METHOD FOR ALLOCATING THE INTERNET PROTOCOL FOR TERMINAL IN CODE DIVISION MULTIPLE ACCESS SYSTEM earlier filed in the Korean Intellectual Property Office on Sep. 11, 2002 and there duly assigned Serial No. 2002-55152.

### BACKGROUND OF THE INVENTION

1. Field of the Invention

The present invention relates to a method for assigning an IP (Internet Protocol) address to an MN (Mobile Node) in a CDMA (Code Division Multiple Access) system, and more particularly to a method for assigning an IP address on the basis of a grade of an MN.

2. Description of the Related Art

In a CDMA (Code Division Multiple Access) 2000 EVDO (Evolution Data Only) system as a CDMA2000 packet data system for a private network, which supports a 3G-1x InfoMobile service and a private data service, a public network-based PDSN (Packet Data Serving Node) and data service equipment are implemented as functional modules inside the system to support a radio packet Internet service. A 3G-1x system performs existing A-R (ATP (Air Terminal Processor)-RPP (Radio access network-Packet data network interface Processor)) and R-P (RPP-PDSN) interface functions and a partial function of the PDSN by embedding an RPP board connected to a GAN (Global Access Network) ATM (Asynchronous Transfer Mode) switch in a private BSC (Base Station Controller) system. The CDMA2000 EVDO system provides the private data service by including a PCF (Packet Control Function) module and a pPDSN (private PDSN). The pPDSN of the 3G-1x system and the PCF module and pPDSN of the EVDO system perform functions, as in the following. First, they perform a packet call control and state transition function for a private packet call. Second, they perform a PPP (Point-to-Point Protocol) daemon function for a radio packet Internet service based on a private network. Third, they perform a traffic signalling function for packet data and a PNA (Packet Network Architecture) function. Fourth, they perform a dormant buffering and paging request function, a packet link register function and a packet O&M (Operation & Management) function.

A pPDSN of the 3G-1x system and the PCF module and pPDSN of the EVDO system include a pPDP (private Packet Data serving node Processor), a PDCC (Packet Data Call Control) module, a PDTC (Packet Data Traffic Control) module and a PDMA (Packet Data Maintenance Administration) module.

The PDCC module manages generation/termination of an RP connection needed for data transmission and reception by an MN (Mobile Node) between an ATP and a DCN (Data Communication Network), and processes a state of a packet call. The PDTC module is responsible for the data transmission and reception between the ATP and the DCN. The PDMA module is responsible for forming interfaces with O&M function modules. Moreover, the PDMA module checks a state of a link coupled to the ATP, a state of a link coupled to the DCN, etc.

The PDTC of the 3G-1x system and the pPDSN of the EVDO system perform a process associated with an IP address assignment of the PPP (IPCP (Internet Protocol Control Protocol)) between a module responsible for a PPP (Point-to-Point Protocol) daemon and the MN. The following procedure must be performed so that the IP address assignment can be completed.

A PPP setup procedure is performed through a flow of signals between an MN (Mobile Node), a PCF module, a pPDSN and an AAA (Administration, Authorization and Authentication) module. In the conventional PPP setup procedure, a PPPD (Point-to-Point Protocol Daemon) sequentially assigns IP addresses stored in an IP address pool according to a message of IPCP_Config_Req transmitted from the MN to the pPDSN. That is, the conventional method sequentially assigns IP addresses to MNs on the basis of IP address assignment requests. However, there is a problem in that the conventional method cannot assign IP addresses according to grades of MNs. Thus, a method for assigning a specific IP address to a specific MN on the basis of a grade of the MN is seriously needed.

### SUMMARY OF THE INVENTION

Therefore, the present invention has been made in view of the above and other problems, and it is an object of the present invention to provide a method for assigning an IP (Internet Protocol) address on the basis of a grade of an MN (Mobile Node).

It is another object to provide a technique for assigning an IP address to a mobile node that can reduce costs for security.

It is yet another object to provide a technique for assigning an IP address to a mobile node that is easy and inexpensive to implement.

It is still another object to provide an apparatus and technique, in especially a code division multiple access system, that can more efficiently tailor the services provided for certain mobile users.

In accordance with an aspect of the present invention, the above and other objects can be accomplished by the provision of a method for assigning an IP (Internet Protocol) address on the basis of a grade of an MN (Mobile Node) in a CDMA (Code Division Multiple Access) data communication system, including: a database storing identification information of the MN and grades of MNs indicating a grade of qualification for assignment of the Internet protocol address; when an IP address assignment request associated with an arbitrary MN is received, identifying a grade of the MN from the database; selecting an IP address pool from IP address pools of various grades on the basis of the grade of the MN, the IP address pools containing assignable IP addresses; and selecting an IP address from the IP address pool and assigning the selected IP address to the MN.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating a private PDSN (Packet Data Serving Node) system;

FIG. 2 is a flow chart illustrating a flow of messages at a time of a conventional PPP (Point-to-Point Protocol) setup;

FIG. 3 is a view illustrating a configuration of a CDMA (Code Division Multiple Access) 2000 3G-1x system in accordance with an embodiment of the present invention;

FIG. 4 is a view illustrating a configuration of a CDMA2000 EVDO (Evolution Data Only) system in accordance with an embodiment of the present invention; and

FIG. 5 is a flow chart illustrating a method for assigning an IP (Internet Protocol) address on the basis of a grade of an MN (Mobile Node) in accordance with an embodiment of the present invention.

### DETAILED DESCRIPTION OF THE PREFERRED EMBODIMENTS

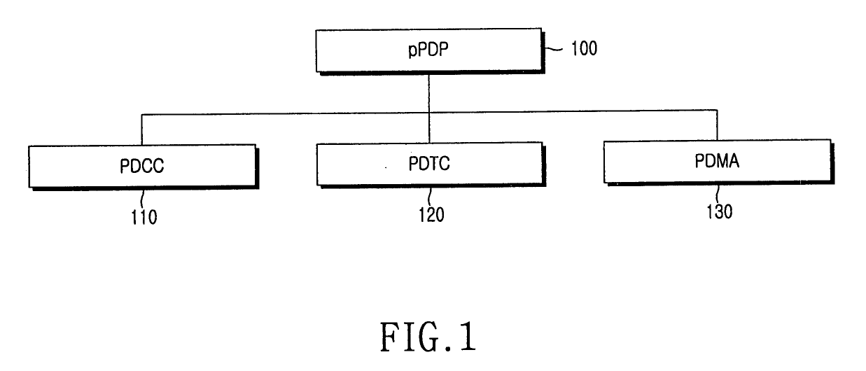

Turning now to the drawings, FIG. 1 is a block diagram illustrating internal structures of the pPDSN of the 3G-1x system and the PCF module and pPDSN of the EVDO system. As shown in FIG. 1, the pPDSN of the 3G-1x system and the PCF module and pPDSN of the EVDO system include a pPDP (private Packet Data serving node Processor) 100, a PDCC (Packet Data Call Control) module 110, a PDTC (Packet Data Traffic Control) module 120 and a PDMA (Packet Data Maintenance Administration) module 130.

The PDCC module 110 manages generation/termination of an RP connection needed for data transmission and reception by an MN (Mobile Node) between an ATP and a DCN (Data Communication Network), and processes a state of a packet call. The PDTC module 120 is responsible for the data transmission and reception between the ATP and the DCN. The PDMA module 130 is responsible for forming interfaces with O&M function modules. Moreover, the PDMA module 130 checks a state of a link coupled to the ATP, a state of a link coupled to the DCN, etc.

The PDTC of the 3G-1x system and the pPDSN of the EVDO system perform a process associated with an IP address assignment of the PPP (IPCP (Internet Protocol Control Protocol)) between a module responsible for a PPP (Point-to-Point Protocol) daemon and the MN. The following procedure must be performed so that the IP address assignment can be completed.

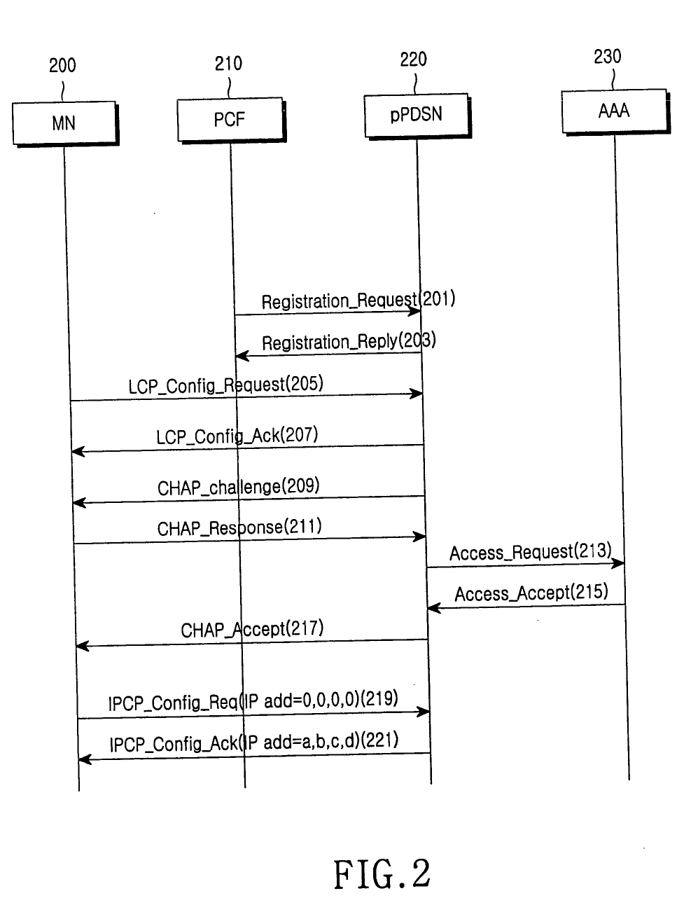

FIG. 2 is a flow chart illustrating a flow of messages at a time of a conventional PPP setup.

As shown in FIG. 2, a PPP setup procedure is performed through a flow of signals between an MN (Mobile Node) 200, a PCF module 210, a pPDSN 220 and an AAA (Administration, Authorization and Authentication) module 230. As shown in FIG. 2, in the conventional PPP setup procedure, a PPPD (Point-to-Point Protocol Daemon) sequentially assigns IP addresses stored in an IP address pool according to a message of IPCP_Config_Req 219 transmitted from the MN 200 to the pPDSN 220. That is, the conventional method sequentially assigns IP addresses to MNs on the basis of IP address assignment requests. However, there is a problem in that the conventional method cannot assign IP addresses according to grades of MNs. Thus, a method for assigning a specific IP address to a specific MN on the basis of a grade of the MN is seriously needed.

Now, preferred embodiments of the present invention will be described in detail with reference to the annexed drawings. In the drawings, the same or similar elements are denoted by the same reference numerals even though they are depicted in different drawings.

As described below, the present invention is to perform an IP (Internet Protocol) address assignment on the basis of a grade of an MN (Mobile Node). That is, the present invention relates to a method for assigning an IP address as one of the important functions performed by a pPDSN (private Packet Data Serving Node). The present invention provides a management and service for the MN by assigning an IP address based on a grade of the MN requesting a PPP (Point-to-Point Protocol) according to a predetermined rule. Through the above-described IP address assignment method, the present invention enables a powerful security function to be implemented in an IP environment. Hereinafter, in embodiments of the present invention, a method for assigning a specific IP address based on a grade of an MN using an IP address pool and another method for assigning a specific IP address using an MIN (Mobile Identification Number)/IMSI (International Mobile Subscriber Identity) for identifying an MN will be described. First, when the method for assigning a specific IP address based on a grade of an MN using an IP address pool is used in the present invention, a PDSN (Packet Data Serving Node) requests a DB (DataBase) storing the grades of the MNs to send the grade of the MN, and assigns an IP address appropriate for the MN's grade received from the LP address pool, where the PDSN uses the IP address pool based on the number of grades and receives an IPCP (Internet Protocol Control Protocol) request. Hereinafter, the first method is referred to as a first embodiment. Second, when the method for assigning the specific IP address using the MIN/IMSI of the MN is used in the present invention, a pPDSN assigns an IP address to the MN using a mapping table of MINs/IMSIs and IP addresses to be assigned at an LCP (Link Control Protocol) stage, wherein the mapping table is contained in a DB containing the MIN/IMSI of MNs. Hereinafter, the second method is referred to as a second embodiment.

To perform the operations described above, the pPDSN can manage a plurality of address pools or must have mapping tables. When the IP address is assigned, an operation of requesting the DB to send a grade of an MN or an IP address to be assigned must be performed using IMSI/MIN values of MNs. On the other hand, the pPDSN has the DB containing MN information and grades of MNs. Alternatively, another server can manage the DB.

The present invention can assign the IP address according to the grade of the MN as described above. Thus, a manager can restrict a service for the MN using IP information based on a grade assigned to the MN or provide a service for only a specific MN. Further, a separate charging policy is applied on an MN basis. For example, free data services are provided to A-grade MNs capable of accessing a specific server, and pay data services are provided to B-grade MNs capable of accessing a specific server. Moreover, a security policy can be established such that secure information can be accessed by only employees in a specific area requiring security and cannot be accessed by many and unspecified persons.

Hereinafter, an exemplary system to which embodiments of the present inventions are applied will be described. In explaining the exemplary system, parts not directly associated with the present invention will not be described.

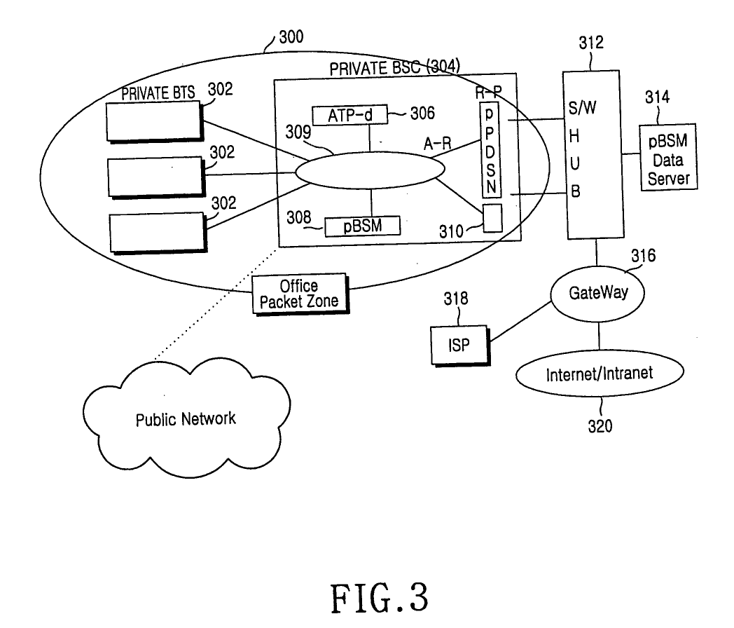

FIG. 3 shows a configuration of a CDMA (Code Division Multiple Access) 2000 3G-1x system.

Referring to FIG. 3, an MN (not shown) is connected to a pBSC (private BSC) 304 through at least one of pBTSs (private BTSs (Base Transceiver Stations)) 302. The pBSC 304 includes a BMP (BSC Main Processor) 309, an ATP (Air Terminal Processor) 306 connected to the BMP 309, a pBSM (private Base Station Manager) 308 and a pPDSN (private Packet Data Serving Node) 310. The pBSC 304 includes a PCF (Packet Control Function) module (not shown) being a router for connecting a pBTS 302 to the pPDSN 310.

The pPDSN 310 is connected to an Internet/Intranet 320 through a hub 312 and a gateway 316. Moreover, the pPDSN 310 is connected to an ISP (Internet Service Provider) 318 through the hub 312 and the gateway 316. In accordance with the present invention, a pBSM data server 314 connected to the pPDSN 310 stores information of the MN as key values of an IMSI or MIN of the MN. In detail, the pBSM data server 314 stores grades of MNs or a mapping table including MINs/IMSIs of MNs and IP addresses to be assigned.

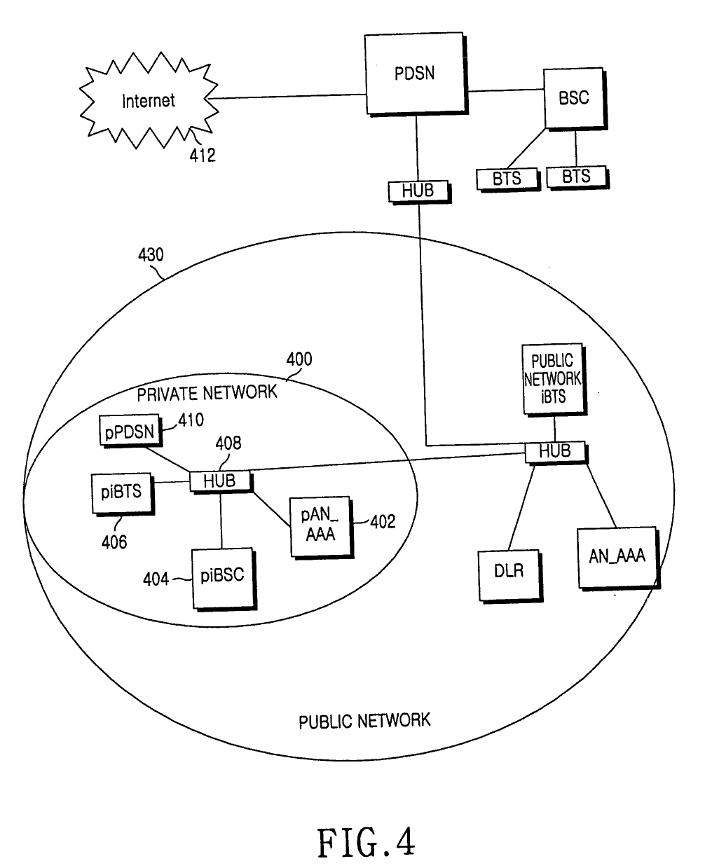

FIG. 4 shows a configuration of a CDMA2000 EVDO system. Referring to FIG. 4, the CDMA2000 EVDO system includes a private network 400 and a public network 430. In the private network 400, a mobile node (not shown) communicates with a piBTS 406 by radio. The piBTS 406 is connected to a piBSC 404, and the piBSC 404 is connected to the Internet through a pPDSN 410. The pPDSN 410 exchanges necessary information with a private AAA (Administration, Authorization and Authentication) server 402 to provide a packet data service to the MN. The piBSC 404 includes a PCF (Packet Control Function) module (not shown) being a router for a connection of the pPDSN 410.

In accordance with the present invention, the private network 400 includes a DB (DataBase) (not shown) for storing information of the MN as key values of an IMSI or MIN of the MN. In detail, the DB similar to the pBSM data server 314 shown in FIG. 3 stores grades of MNs or a mapping table including MINs/IMSIs of MNs and IP addresses to be assigned.

An operation of the pPDSN shown in FIGS. 3 and 4 in accordance with the present invention is as follows. Where receiving an IP address assignment request from the MN, the pPDSN requests the DB or data server to send information of a grade of an MN or an IP address to be assigned using key values of an IMSI or MIN of the MN such that the IP address can be assigned on a grade basis. At this time, the DB or data server searches for information of the grade of the MN or the IP address to be assigned using the IMSI (or MIN), and sends the searched information to the pPDSN. The pPDSN 220 selects an IP address from an IP address pool using the information from the DB or data server. That is, the pPDSN selects an IP address pool corresponding to grades of MNs from IP address pools based on various grades and sequentially assigns IP addresses of a corresponding IP address pool.

In accordance with another embodiment of the present invention, the pPDSN assigns IP addresses to MNs using MINs/IMSIs of the MNs and a mapping table contained in the DB or data server, the mapping table having MINs/IMSIs and IP addresses.

Among components shown in FIGS. 3 and 4 in accordance with the present invention, a component for assigning IP addresses to MNs is the pPDSN 220. A configuration of the pPDSN 220 is as described above. The pPDSN 220 can integrate the DB or data server including an IP address pool of IP addresses to be assigned or a mapping table.

Alternatively, another database for storing grades of MNs or IP address-related information other than the above-described configuration can be added to perform an embodiment of the present invention. In the above-described system, the method of the present invention will be performed as follows.

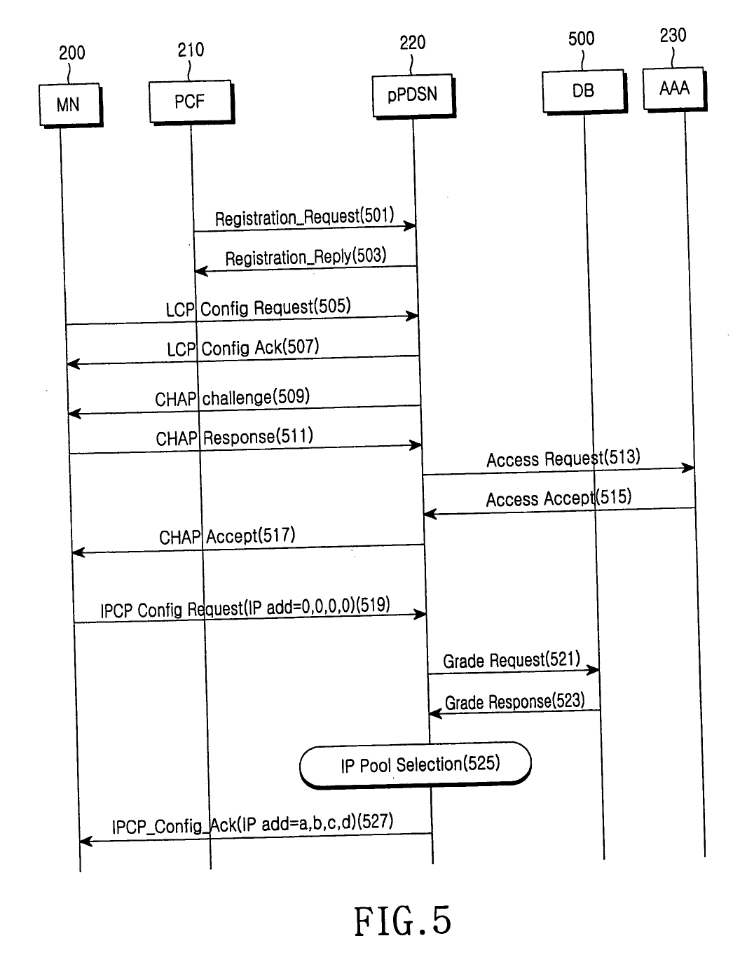

FIG. 5 is a flow chart illustrating a method for assigning an IP address on the basis of a grade of an MN in accordance with an embodiment of the present invention.

As shown in FIG. 5, steps 501 to 519 are for authentication, environment setting, a connection request and an IP address assignment request. The above steps are the same as those of a conventional IP address assignment procedure shown in FIG. 2.

On the other hand, generally in a PPP setup procedure, the pPDSN 220 receiving an IPCP configuration request from an MN 200 at the above step 519 transmits a grade request to a DB 500 at step 521. That is, at the above step 521, the pPDSN 220 requests the DB 500 to send information of a grade corresponding to the MN or an IP address to be assigned using a key value as an IMSI or MIN of the MN 200. In response to the grade request of a specific MN from the pPDSN 220, the DB 500 searches for information of the grade of the MN previously registered or the IP address to be assigned using the IMSI (or MIN) and transmits a result of the search to the pPDSN 220. After receiving the information of the grade of the MN from the DB 500, the pPDSN 220 selects the IP address from an IP address pool using the information at step 525. That is, the pPDSN 220 selects an IP address pool corresponding to the grade of the MN from IP address pools based on various grades using the information and sequentially assigns, to MNs, IP addresses, which can be assigned from the IP address pool. At step 527, the pPDSN 220 transmits the IP address assigned to the MN at the above step 525 to the MN 200, thereby performing an IP address assignment procedure based on the grade of the MN. On the other hand, because the IP address assignment method using the IP address pool is well known, this will not be described.

In addition to the method for selecting the IP address pool corresponding to a grade of an MN from IP address pools based on various grades and assigning an IP address of the selected IP address pool to the MN, a method for assigning a specific IP address using MIN/IMSI values of MNs can be used. When the IP address is assigned using the MIN/IMSI values of the MNs, the pPDSN 220 must include a mapping table of the MIN/IMSI values of the MNs and IP addresses to be assigned. That is, the pPDSN 220 selects an IP address corresponding to an MIN/IMSI value of the MN, thereby performing an IP address assignment procedure based on a grade of an MN.

To implement the procedure based on the embodiment of the present invention, the pPDSN 220 must manage the IP address pools based on the various grades and have a function of inserting/changing/deleting an IP address of each IP address pool.

The techniques of the present invention can also be embodied through a computer readable code or computer-executable instructions on a computer readable medium. The computer readable medium can be any data storage device (e.g. non volatile read-only memory, random access memory, floppy disks, compact discs, digital versatile discs, hard disk drives, flash read-only memories, other optical and magnetic mediums, any media that can store data signals, etc.) that can store data which can be read by a computer system that includes a processor for processing the instructions on the computer readable medium.

As described above, the present invention classifies and manages an IP address assignment based on a grade of a MN, so that a system manager can control a subscriber's authority. Because a server can open only information for a specific IP address to many and unspecified persons, security can be maintained without a separate firewall, and costs for installing the firewall can thus be saved. Since the present invention can attract and differentiate higher-grade subscribers and hence charges for contents are different according to grades of subscribers, better services can be provided.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

What is claimed is:

1. A method for assigning an Internet protocol address to a mobile node in a mobile communication system, comprising the steps of:
storing, by a database, identification information of said mobile node and grades of mobile nodes indicating a grade of qualification for assignment of the Internet protocol address;
when an Internet protocol address assignment request associated with an arbitrary mobile node is received, identifying a grade of said mobile node from said database;
selecting an Internet protocol address pool from Internet protocol address pools of various grades on the basis of the grade of said mobile node, the Internet protocol address pools containing assignable Internet protocol addresses; and
selecting an available Internet protocol address from the Internet protocol address pool and assigning the selected Internet protocol address to said mobile node.

2. A method for assigning an Internet protocol address to a mobile node in a mobile communication system, comprising the steps of:
storing, by a database, identification information of said mobile node and grades of mobile nodes indicating a grade of qualification for assignment of the Internet protocol address;
storing, by a mapping table, Internet protocol addresses to be assigned, corresponding to the identification information of said mobile node;
when an Internet protocol address assignment request associated with an arbitrary mobile node is received, identifying the grade of said mobile node to be assigned to said mobile node and specific information of said mobile node from said database; and
selecting an Internet protocol address to be assigned to said mobile node from a mapping table according to the grade of said mobile node.

3. The method as set forth in claim 2, wherein said mobile node identification information is characterized by one of mobile identification number and international mobile subscriber identity.

4. An apparatus, comprising:
a mobile node;
a first unit storing grade information of a plurality of mobile nodes indicating a grade of qualification for assignment of Internet protocol address;
a second unit requesting said first unit storing the grades of the mobile nodes to send the grade of said mobile node, and selecting Internet protocol address pool from multiple grades of Internet protocol address pool including assignable Internet address pools according to the grade of said received mobile node and assigning an Internet protocol address according to the grade of the mobile node received from an Internet protocol address pool.

5. The apparatus of claim 4, further comprised of:
said first unit identifying an Internet protocol grade to be assigned to said mobile node and specific information of said mobile node; and
said second unit selecting an Internet protocol address to be assigned to said mobile node from a mapping table, said mapping table storing Internet protocol addresses to be assigned according to the specific information of the mobile nodes.

6. The apparatus of claim 4, further comprised of said first unit storing grade information of said mobile node as key values of a specific information of said mobile node.

7. The apparatus of claim 6, further comprised of said first unit being a database.

8. The apparatus of claim 7, further comprised of said second unit being a packet data serving node.

9. The apparatus of claim 8, with said specific information being any one of a mobile identification number and an international mobile subscriber identity for said mobile node.

10. The apparatus of claim 4, further comprising a data server connected to said second unit storing grades of mobile nodes or a mapping table including international mobile subscriber identity or mobile identification number of the mobile nodes and Internet protocol addresses to be assigned.

11. A system for assigning an Internet protocol address, comprising:
a computer readable medium;
a processor connected to said computer readable medium, said processor programmed to:
storing, by a database, identification information of said mobile node and grades of mobile nodes indicating a grade of qualification for assignment of the Internet protocol address;
when an Internet protocol address assignment request associated with an arbitrary mobile node is received, identifying a grade of a mobile node from a database;
selecting an Internet protocol address pool from Internet protocol address pools of various grades on the basis of the grade of said mobile node, the Internet protocol address pools containing assignable Internet protocol addresses; and
selecting an Internet protocol address from the Internet protocol address pool and assigning the selected Internet protocol address to said mobile node.

12. The system of claim 11, further comprised of assigning the Internet protocol address on the basis of the grade of said mobile node in a code division multiple access data communication system.
